(19) United States
(12) Patent Application Publication
(10) Pub. No.: US 2026/0021674 A1
(43) Pub. Date: Jan. 22, 2026

(54) BOOK OR BINDING DEVICE THAT INCLUDES A SERIES OF FOLDING AND/OR CUTTING GUIDES INTO THE PAGES IN ORDER TO FORM FIGURES ON THE FORE-EDGE

(71) Applicant: Jose Aburto Zolezzi, Lima (PE)

(72) Inventor: Jose Aburto Zolezzi, Lima (PE)

(21) Appl. No.: 19/270,888

(22) Filed: Jul. 16, 2025

Related U.S. Application Data
(60) Provisional application No. 63/672,822, filed on Jul. 18, 2024.

(51) Int. Cl. B42D 1/00

(52) U.S. Cl. CPC B42D 1/006

(57) ABSTRACT

A front cover, a back cover, and a plurality of pages bound together with the front cover and the back cover. The plurality of pages comprise a combination of cutting guides and folding guides and colored areas that when cut and folded according to the pre-defined instructions create when viewed from the fore-edge a three-dimensional structure.

### PRIORITY

This application claims the benefit of U.S. Provisional Patent Application No. 63/672,822 filed Jul. 18, 2024, which is incorporated by reference herein in its entirety.

### TECHNICAL FIELD

The present disclosure relates to books and bound devices with interactive features for enhanced reader engagement; and more specifically, this disclosure pertains to bound media incorporating folding and cutting guides to create three-dimensional structures on the fore-edge while preserving content readability.

### BACKGROUND INFORMATION

Books have long served as a cornerstone for sharing knowledge, storytelling, and entertainment, traditionally delivering a static reading experience through printed text and images on bound pages. However, with the advent of digital media and shifting reader preferences, traditional books encounter significant challenges in maintaining reader engagement, especially with lengthy or complex texts. Many readers, particularly younger audiences and those accustomed to dynamic, interactive media, find it difficult to stay focused and motivated during extended reading sessions due to the passive nature of conventional book formats. This growing disengagement underscores the limitations of traditional books, which lack features to actively involve readers or provide a sense of progress and reward.

In light of these challenges, there is an increasing demand for innovative solutions that can enrich the reading experience by incorporating interactive elements. Such enhancements could make reading more engaging, rewarding, and accessible, appealing to a wider audience. However, current methods often struggle to integrate interactivity while maintaining the readability and integrity of the book's content, revealing a need for a balanced approach.

Thus, there is a need for a solution that seamlessly integrates interactive features into bound books, enables the creation of visually dynamic designs, and preserves the clarity and essence of the text, all while requiring minimal manual effort. This approach would address the shortcomings of traditional books and meet the evolving expectations of modern readers.

### SUMMARY

Disclosed is a bound device comprising a front cover, a back cover, and a plurality of pages bound together with the front cover and the back cover. The plurality of pages comprise a combination of cutting guides and folding guides and colored areas that when cut and folded according to the pre-defined instructions create when viewed from the fore-edge a three-dimensional structure.

In an embodiment, the cutting guides and folding guides are printed on the plurality of pages. The colored areas are printed on the plurality of pages. Alternatively, the folding guides are one chosen from printed, perforated, and embossed, and the cutting guides are one chosen from printed and perforated. Ideally, the folding guides, cutting guides, and colored areas are contained within margins of the plurality of pages to leave a content area un-obstructed by the folding and cutting of the plurality of pages. In embodiments, at least one of the plurality of pages includes multiple folding guides for creating multiple folds on the page, and the folding guides include numbered steps or directional arrows to indicate the sequence of folds.

In an embodiment, the bound device comprises a closure device with one end secured to one of the front cover and the back cover, and the other end of the closure device securable to the other of the front cover and the back cover. For example, the closure device can be a strap that is secured by one or two points on the front cover to be wrapped around and secured to the back cover. The closure strap is also securable to a number of the plurality of pages to hold them secure while another of the plurality of pages is presented for viewing. Alternatively, the closure device is one of an elastic strap, a fabric strap, a magnetic clasp, and a Velcro strap. The closure strap ideally is configured to separate folded pages from unfolded pages during the folding process.

The foregoing allows the three-dimensional structure to be fully visible and presented when the bound device is closed and viewed from the fore-edge.

In another embodiment, a method for converting a fore-edge of a book into a three-dimensional structure figure is disclosed. The method includes steps for providing the book with a front cover, a back cover, and a plurality of pages bound together with the front cover and the back cover. The plurality of pages include cutting guides, folding guides, and colored areas. A step for cutting the page, for each page of the plurality of pages that includes cutting guides, along the cutting guides is provided along with a step for folding the page, for each page of the plurality of pages that includes folding guides, along the folding guides. The method includes a step for closing the bound device such that the fore-edge of the plurality of pages displays a three-dimensional structure formed by the cut and folded pages and the colored areas.

In an embodiment, the method includes the cutting guides as perforated, and cutting the page comprises tearing along the perforated cutting guides, and the folding guides as perforated, and folding the page comprises folding along the perforated folding guides, and the folding guides as embossed, and folding the page comprises folding along the embossed folding guides. The method can include cutting and folding the pages so that it does not obstruct a content area on the pages, allowing the content to remain readable.

In an embodiment, the method includes using a closure device to secure the bound device in a closed position and to hold a portion of the plurality of pages secure while folding another portion of the plurality of pages. The method can continue with folding the page comprises following numbered steps or directional arrows provided on the page to perform multiple folds in a specified sequence.

### BRIEF DESCRIPTION OF THE DRAWINGS

These and other features and advantages of the present invention will be better understood by reading the following detailed description, taken together with the drawings wherein:

FIG. 1 shows a perspective view of a bound device according to this disclosure.

FIG. 2 shows a series of perspective views to illustrate a step-by-step progression a three-dimensional structure coming to form.

FIG. 3 shows a perspective view of the back of the bound device with a closure element.

FIG. 4 shows a perspective view of the bound device secured in the closed position with the closure element before the three-dimensional structure has been formed.

FIG. 5 is a perspective view of the bound device in the open position when the only one page has been folded illustrating how the folded pages do not obstruct the folding process of the other pages.

FIG. 6 is a perspective view of the completed process with the bound device opened in the middle to show the three-dimensional structure coming to form on the fore-edges of the pages.

FIG. 7 is a series of steps illustrating a simple example of folding a page.

FIG. 8 is a series of steps illustrating a more complex example of folding multiple pages.

FIG. 9 is a series of steps illustrating an example of cutting and folding a page.

FIG. 10 is a series of steps illustrating how a folded and cut page with coloring appears on and near the fore-edge of the page.

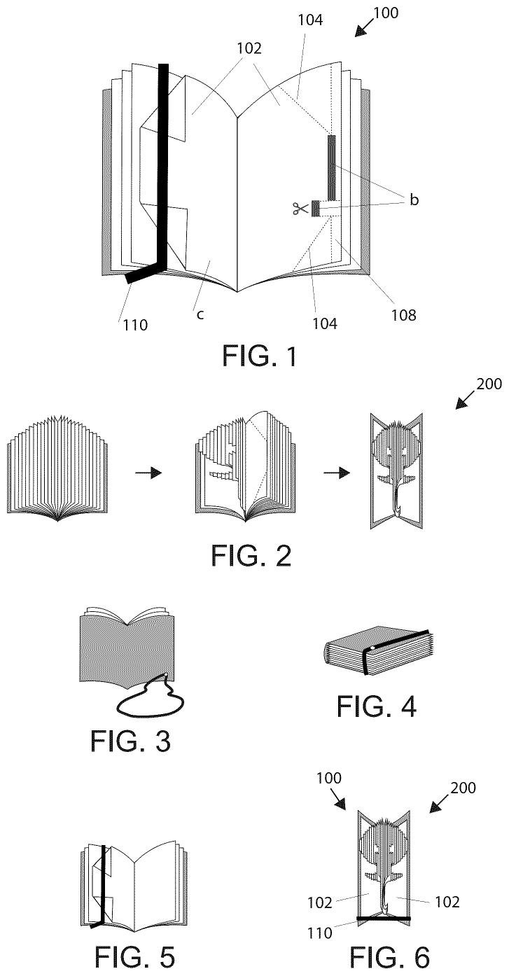

### DETAILED DESCRIPTION OF THE PREFERRED EMBODIMENTS

The present disclosure describes a bound device 100, embodied as a book hereinafter described, that is designed to provide an interactive reading experience. This is achieved through the incorporation on pages 102 of the bound device 100 of folding guides 104, cutting guides 106, and colored areas 107, which instruct the reader on how to fold or cut specific portions of pages 102, while area 101 comprising images and text unobstructed, to create a three-dimensional structure 200 that becomes visible on the fore-edge 108 of bound device 100 when it is closed, as shown in FIGS. 2, and 6. A closure element 110 aids the reader by securing preceding pages 102 or holding bound device 100 in the closed position. A key feature of this invention is that the content printed on pages 102, such as text, images, or other content, remains readable both during and after the folding and cutting process. This ensures that the bound device can still be used for its primary purpose of conveying information, while also offering an additional layer of engagement through the creation of the three-dimensional structure 200. This interactive process engages readers by combining reading with a hands-on activity, rewarding them with the completed three-dimensional structure 200 upon finishing.

Bound device 100 is intended to broadly cover any media with pages held together with a binding on one side and a fore-edge on the other side, such as books (hardcover or paperback), magazines, journals and diaries, catalogs and brochures, scrapbook, etc. Bound device 100 includes fore-edge 108, which is defined by both the individual and collective edges of pages 102. Specifically, each page 102 has fore-edge 108, which is the outer, unbound edge opposite the spine or binding of the bound device 100, where the page 102 is free to be turned. When the bound device 100 is closed, the series of fore-edges 108 of pages 102 align to form the fore-edge 108 of the bound device 100, presenting a unified surface visible along the unbound side of bound device 100. This fore-edge 108 of the bound device 100 serves as the canvas for the three-dimensional structure 200, which is created through the folding and/or cutting of pages 102 guided by folding guides 104 and cutting guides 106, as illustrated in FIG. 6. The colored areas 107 on the fore-edges 108 of pages 102 contribute to the visual appearance of the three-dimensional structure 200 on the fore-edge 108 of the bound device 100, as shown in FIG. 10. This dual use of the term fore-edge 108, referring to both the edge of each page 102 and the collective edge of the bound device 100, reflects the structural relationship wherein the individual fore-edges 108 of pages 102 collectively define the fore-edge 108 of the bound device 100 when closed.

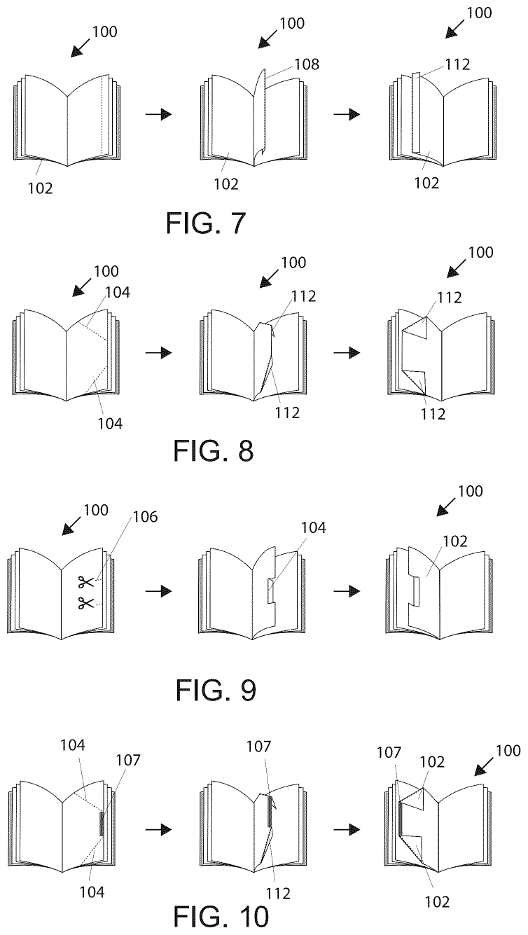

More specifically, each of pages 102 includes one or more folding guides 104, which may comprise of lines, arrows, or other indicators printed on pages 102 that show where and how to fold specific portions of pages 102. Turning to FIGS. 7-8, shown are a series of steps illustrating a simple example (FIG. 7) and a more complex example (FIG. 8). As can be seen in each of FIGS. 7-8, folding guide 104 is shown as one or more dashed lines indicating where the reader should fold page 102. In FIG. 7, for example, in FIG. 8, for example, page 102 indicates folding guides 112 with two diagonal dashed lines to indicate to the reader to create two diagonal folds (i.e., dog-ears). In each of these examples, area 101 with images and text is unobscured allowing the reader to remain engaged with the book while taking initial steps to form three-dimensional structure 200 on the fore-edge 108 of bound device 100. For pages 102 that contain more complex folding guides 104, numbered steps or directional arrows to ensure the reader performs the folds in the correct sequence may be provided.

Similarly, cutting guides 106 may be provided. These cutting guides may also comprise of lines, arrows, or patterns on printed on pages 102 that indicate where to the reader where to make the cuts. These cuts on pages 102 are necessary to create flaps or openings that contribute to the three-dimensional structure 200 when pages 102 are folded according to folding guides 104. Turning to FIG. 9, shown are a series of steps illustrating a simple example of cutting and folding a page.

FIG. 9 is a series of steps illustrating how a folded and cut page with coloring appears on and near the fore-edge of the page. As can be seen in FIG. 9, cutting guide 106 is shown as one or more dashed lines indicating where the reader should cut page 102. Page 102 indicates to the reader to cut page 102 from in two places each beginning at fore-edge 108 a short distance toward the binder to create a flap 114 that can be folded inward. Note area 101 with images and text is unobscured allowing the reader to remain engaged with the book while taking initial steps to form three-dimensional structure 200 on the fore-edge 108 of bound device 100.

FIG. 10 illustrates how colored area 107 can be combined with one or both of folding guides 104 and cutting guides 106 in a series of steps illustrating how a folded and/or cut page 102 with colored area 107 appears on and near the fore-edge 108 of page 102. Colored areas 107 are printed on the pages 102 near the fore-edge 108, aligning with the folded or cut sections to add color to the three-dimensional structure 200 when viewed from the fore-edge.

Bound device 100 enables an integrated process wherein the folding guides 104 and cutting guides 106 on each page 102 interact seamlessly with the colored areas 107 to construct the three-dimensional structure 200 along the fore-edge 108. Turning to FIG. 2, shown are a series of perspective views to illustrate a step-by-step progression a three-dimensional structure 200 coming to form. As the reader manipulates pages 102 according to folding guides 104 and cutting guides 106, folding along designated lines or cutting along specified paths, the colored areas 107, positioned proximate to the fore-edge 108, align or become exposed to enhance the visual complexity of three-dimensional structure 200. For instance, a fold along a folding guide 104 may reveal a segment of a colored area 107 that, when viewed collectively across multiple pages 102 enhances the collective fore-edge 108 of the bound device 100 and forms a portion of a cohesive image or pattern. Similarly, a cut along a cutting guide 106 may produce flap 114 that, when folded, introduces depth and additional color elements to the fore-edge design. This coordinated operation transforms the bound device 100 into an interactive medium, wherein each modification contributes incrementally to the final three-dimensional effect.

Bound device 100 may be implemented in multiple structural configurations to accommodate diverse applications and user preferences. In one variation, bound device 100 is embodied as a softcover book, featuring a flexible cover that facilitates ease of handling and portability. Here, the folding guides 104 and cutting guides 106 are printed with precision to account for the pliability of pages 102, ensuring that folds and cuts remain consistent despite the cover's flexibility. Colored areas 107 in this embodiment are applied with resilient inks to endure repeated manipulation. Alternatively, bound device may take the form of a hardcover book, equipped with a rigid cover that enhances durability and structural integrity. In this configuration, folding guides 104 and cutting guides 106 are tailored to the stiffer pages, promoting precise and stable modifications, while the colored areas 107 are integrated to maintain their visibility and alignment over time. Both embodiments utilize closure element 110, customized to the cover type to secure the device during use or display.

To broaden the accessibility and functionality of bound device 100, folding guides 104 and cutting guides 106 may be provided in alternative configurations. One such configuration includes perforated folding guides 124, wherein the guide lines are perforated to enable effortless tearing or folding without additional tools, benefiting users with limited dexterity or younger readers. Another option is embossed folding guides 126, featuring raised lines that offer tactile guidance, assisting individuals who rely on touch for navigation. For safety and convenience, pre-cut flaps 128 may be incorporated, where designated sections of the pages 102 are pre-cut by the manufacturer, eliminating the need for cutting tools and reducing potential hazards. Additionally, textured folding zones 130 may be employed, applying distinct textures to specific page regions to indicate folding locations, thereby enhancing usability for visually impaired individuals. These variations ensure that the invention is adaptable to a wide range of user needs and preferences.

Closure element 110 is designed with multiple adaptations to support the operational stages of bound device 100, including storage, folding, and exhibition of the three-dimensional structure 200 on the fore-edge of bound device 100. In one adaptation, closure element 110 is an elastic strap, stretchable around bound device 100 to secure it closed or to hold specific pages during the folding process. As shown in FIG. 4, the closure element 110 secures the bound device 100 during storage. During active folding, closure element 110 can be looped around folded pages 102 to separate them from unfolded ones (see FIG. 5). For exhibition, it can be stretched around the closed book to maintain its display position (see FIG. 6). Alternatively, a fabric ribbon may be used, capable of being tied or looped around bound device 100, adding both utility and aesthetic appeal. For enhanced security, a magnetic clasp provides a firm yet easily accessible closure, ideal for maintaining the shape during display. Another variation includes a Velcro loop offering adjustable tension and simplicity of use. Each adaptation of closure element 110 is engineered to complement the folding cycle, ensuring that bound device 100 remains functional and visually intact across its various stages of transformation.

The design of bound device 100 prioritizes the accessibility of the content area 101, ensuring that the interactive features do not detract from its primary purpose as a readable medium. Folding guides 104, cutting guides 106, and colored areas 107 are strategically placed outside the central content zone, typically within the margins or adjacent to the fore-edge 108 to preserve the legibility of text, images, or other media. This layout is meticulously planned during production where folding guide 104 resides in the margin, leaving the textual content undisturbed. Likewise cutting guide 106 is positioned near the fore-edge, ensuring no overlap with content area 101. By confining folding and cutting to the margins near the fore-edge, the central content area 101 remains unaffected and readable even after the structure 200 is formed. These considerations enable the reader to engage fully with the folding and cutting processes while retaining unobstructed access to the printed material, thereby balancing interactivity with utility.

In an exemplary preferred embodiment, referring to FIG. 2, bound device 100 is configured as a book measuring 28 cm in height by 20 cm in width, comprising approximately 400 pages 102. Each page 102 features folding guides 104 and cutting guides 106 that direct the reader to fold and cut specific sections, ultimately forming three-dimensional structure 200 resembling a blue elephant's head along fore-edge 108, which is especially apparent when the book is closed viewing it towards the fore-edge. Colored areas 107, printed in blue near the fore-edge, align with the folded and cut portions to produce the intended visual effect. Closure element 110 in this embodiment is a 55 cm elastic strap 132, affixed to the cover 3 cm from the bottom edge and 2.5 cm from the outer edge. This strap secures the book in its closed state, separates folded from unfolded pages during construction, and holds the book open for display upon completion.

This disclosure accommodates an extensive scope of alternative embodiments to address varying user requirements and design objectives. Bound device 100 may range in size from compact, pocket-sized editions to expansive, large-format volumes, with page counts spanning from dozens to hundreds. Three-dimensional structure 200 can vary in complexity, from basic geometric forms to elaborate, detailed figures. Guide options include perforated folding guides, embossed folding guides, pre-cut flaps, and textured folding zones, each tailored to specific usability enhancements. Closure element 110 may similarly be adapted, utilizing materials and mechanisms such as elastic straps, fabric ribbons, magnetic clasps, or Velcro loops. These adaptations enable the invention to serve diverse audiences, such as children, educators, or hobbyists, and various formats, including notebooks, manuals, or art books, ensuring broad applicability and user engagement.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. A bound device comprising:
a front cover;
a back cover;
a plurality of pages bound together with the front cover and the back cover;
wherein the plurality of pages comprise a combination of cutting guides and folding guides and colored areas that when cut and folded according to the pre-defined instructions create when viewed from the fore-edge a three-dimensional structure.

2. The bound device of claim 1, wherein the cutting guides and folding guides are printed on the plurality of pages.

3. The bound device of claim 1, wherein the colored areas are printed on the plurality of pages.

4. The bound device of claim 1, wherein the folding guides are one chosen from printed, perforated, and embossed.

5. The bound device of claim 1, wherein the cutting guides are one chosen from printed and perforated.

6. The bound device of claim 1, wherein the folding guides, cutting guides, and colored areas are contained within margins of the plurality of pages to leave a content area un-obstructed by the folding and cutting of the plurality of pages.

7. The bound device of claim 1, and further comprising a closure device with one end secured to one of the front cover and the back cover, and the other end of the closure device securable to the other of the front cover and the back cover.

8. The bound device of claim 7, wherein the closure device is a strap that is securable the other of the front cover and the back cover while also securable to a number of the plurality of pages to hold them secure while another of the plurality of pages is presented for viewing.

9. The bound device of claim 7, wherein the closure device is one of an elastic strap, a fabric strap, a magnetic clasp, and a Velcro strap.

10. The bound device of claim 7, wherein the closure strap is configured to separate folded pages from unfolded pages during the folding process.

11. The bound device of claim 1, wherein the three-dimensional structure is fully visible and presented when the bound device is closed and viewed from the fore-edge.

12. The bound device of claim 1, wherein at least one of the plurality of pages includes multiple folding guides for creating multiple folds on the page; and wherein the folding guides include numbered steps or directional arrows to indicate the sequence of folds.

13. A method for converting a fore-edge of a book into a three-dimensional structure figure, the method comprising:
providing the book comprising a front cover, a back cover, and a plurality of pages bound together with the front cover and the back cover, wherein the plurality of pages include cutting guides, folding guides, and colored areas;
cutting the page, for each page of the plurality of pages that includes cutting guides, along the cutting guides;
folding the page, for each page of the plurality of pages that includes folding guides, along the folding guides;
closing the bound device such that the fore-edge of the plurality of pages displays a three-dimensional structure formed by the cut and folded pages and the colored areas.

14. The method of claim 13, wherein the cutting guides are perforated, and cutting the page comprises tearing along the perforated cutting guides.

15. The method of claim 13, wherein the folding guides are perforated, and folding the page comprises folding along the perforated folding guides.

16. The method of claim 13, wherein the folding guides are embossed, and folding the page comprises folding along the embossed folding guides.

17. The method of claim 13, wherein cutting and folding the pages does not obstruct a content area on the pages, allowing the content to remain readable.

18. The method of claim 13, further comprising using a closure device to secure the bound device in a closed position.

19. The method of claim 13, further comprising using a closure device to hold a portion of the plurality of pages secure while folding another portion of the plurality of pages.

20. The method of claim 13, wherein folding the page comprises following numbered steps or directional arrows provided on the page to perform multiple folds in a specified sequence.
